(19) United States
(12) Patent Application Publication
(10) Pub. No.: US 2008/0012981 A1
(43) Pub. Date: Jan. 17, 2008

(54) Mail processing system with dual camera assembly

(76) Inventors: Mark D. Goodwin, Apalachin, NY (US); Mathew S. Hale, Barton, NY (US); Wayne M. Blackwell, Chenango Forks, NY (US)

Correspondence Address: Lockheed Martin Corporation;c/o WOLF, GREENFIELD & SACKS, P.C., 600 ATLANTIC AVENUE, BOSTON, MA, 02210-2206, US

(21) Appl. No.: 11/824,847

(22) Filed: Jul. 3, 2007

Related U.S. Application Data
(60) Provisional application No. 60/819,136, filed on Jul. 7, 2006.
(60) Provisional application No. 60/819,414, filed on Jul. 7, 2006.
(60) Provisional application No. 60/819,217, filed on Jul. 7, 2006.
(60) Provisional application No. 60/819,084, filed on Jul. 7, 2006.
(60) Provisional application No. 60/819,132, filed on Jul. 7, 2006.
(60) Provisional application No. 60/819,188, filed on Jul. 7, 2006.

(51) Int. Cl. H04N 5/225

(52) U.S. Cl. 348/374

(57) ABSTRACT

A mail processing system with a camera assembly including both a UV imaging camera and a grayscale imaging camera integrated in a single assembly. Integration provides lower costs as well as desirable performance characteristics. However, for the cameras to operate in a compact housing, it is necessary to include mechanisms to prevent interference between the optical paths for the cameras. Interference is avoided by positioning the apertures for the cameras in a convex face of the assembly. Each aperture is mounted in a portion of the surface with a different tangent. Additionally, the a support structure for a UV source and detector array acts as a baffle, further preventing interference.

### CROSS-REFERENCE TO RELATED APPLICATIONS

This application claims the benefit under 35 U.S.C. §119(e) of U.S. Provisional Application Ser. No. 60/819,136, filed Jul. 7, 2006, U.S. Provisional Application Ser. No. 60/819,414, filed Jul. 7, 2006, U.S. Provisional Application Ser. No. 60/819,217, filed Jul. 7, 2006, U.S. Provisional Application Ser. No. 60/819,084, filed Jul. 7, 2006, U.S. Provisional Application Ser. No. 60/819,132, filed Jul. 7, 2006, and U.S. Provisional Application Ser. No. 60/819,188, filed Jul. 7, 2006. Each of the above applications is incorporated herein by reference.

### FIELD OF INVENTION

This invention relates generally to mail processing systems and equipment used therein.

### BACKGROUND

The U.S. Postal Service (USPS) has developed standards for the marking of mailpieces that facilitate the automatic sorting and processing of such items. Such mailpiece features include stamps, meter marks, information based indicia (IBI) barcodes (PDF417 and Data Matrix), facing identification marks (FIM), Postal Numeric Encoding Technique (POSTNET) codes, postal alphanumeric encoding technique (PLANET) codes, 4CB codes, and identification (ID) tags. The purpose and use of such features are well known in the art and thus will not be described in detail.

Line scan cameras have been implemented in numerous industrial and commercial settings, such as on high-speed mail sorting systems. An example of a prior art mail sorting system that employed such cameras, as well as several other components, is illustrated in FIG. 1. As shown, the mail sorting system 2 comprised a singulation stage 4, a first indicia detection stage 6, a facing inversion stage 8, a second indicia detection stage 10, a cancellation stage 12, an inversion stage 14, an ID tag spraying stage 16, an image lifting stage 18, and a stacking stage 20. One or more conveyors (not shown) would move mailpieces 19 from stage to stage in the system 2 (from left to right in FIG. 1) at a rate of approximately 3.6-4.0 meters per second.

The singulation stage 4 included a feeder pickoff 22 and a fine cull 24. The feeder pickoff 22 would generally follow a mail stacker (not shown) and would attempt to feed one mailpiece at a time from the mail stacker to the fine cull 24, with a consistent gap between mailpieces. The fine cull 24 would remove mailpieces that were too tall, too long, or perhaps too stiff. When mailpieces 19 left the fine cull 24, they would ideally be in one of four possible orientations, as illustrated by mailpieces 19a-d.

Each of the first and second indicia detection stages 6, 10 included a pair of indicia detectors 26a-b, 26c-d positioned to check the lower edges (of approximately 1 inch) of the opposite faces of a passing mailpiece 19 for reactance to ultraviolet (UV) radiation and for FIM marks, and thereby detect indicia at such locations. As used herein, “indicia” refers to any marking on a mailpiece that represents a postage value. If the first indicia detection stage 6 failed to detect any indicia on either lower edge of a given mailpiece, that mailpiece would be inverted by an inverter 9 at the facing inversion stage 10 so as to allow the second indicia detection stage 10 to check the lower one inch edges of the other side of the mailpiece for indicia. As a result, each mailpiece 19 that had detectable indicia thereon ideally ended up positioned with the edge containing the indicia (the “top edge” of the mailpiece) facing downward after it left the second indicia detection stage 10, with at least one of the indicia detectors 26a-d having identified the face of the mailpiece that contained the indicia.

The cancellation stage 12 included a pair of cancellers 28a-b arranged to spray one side of the top edge of the mailpiece (i.e., the side determined to contain the indicia), and thereby cancel the indicia. Following the cancellation stage 12, each mailpiece would be inverted by an inverter 15 at the inversion stage 14 so that the top edge of the mailpiece was made to face upwards. The ID tag spraying stage 16 included a pair of ID tag sprayers 30a-b arranged to spray an ID tag, as needed, along an appropriate one of the two lower edges of the mailpiece, as determined by the facing decision made by the indicia detection stages 6, 10.

The image lifting stage 18 included a pair of line scanning cameras 32a-b that imaged the mailpiece. Each line scanning camera provided a two hundred and twelve pixel per inch (PPI) image for address recognition. An analysis of the accumulated images facilitated a determination of the one of several output bins 34a-g of the stacking stage 20 into which the mailpieces was to be stacked based on certain criteria.

### SUMMARY

In one aspect, the invention relates to a mail processing system having a camera assembly. A housing for the camera assembly has a face with at least a first aperture and a second aperture. A first imaging array is mounted within the housing in a position to receive radiation passing through the first aperture. A second imaging array is mounted within the housing in a position to receive radiation passing the second aperture.

In another aspect, the invention relates to a mail processing system having a mail conveyor and a camera assembly. The camera assembly has housing with a face having at least a first aperture and a second aperture. The face is adjacent the mail conveyor. A first imaging array mounted within the housing is positioned to receive radiation passing through the first aperture and a second imaging array mounted within the housing is positioned to receive radiation passing through the second aperture. A first radiation source mounted to the housing is positioned to illuminate a region of a mailpiece adjacent the first aperture. A second radiation source mounted to the housing is positioned to illuminate a second region of a mailpiece adjacent the second aperture.

In yet a further aspect, the invention relates to a method of operating a mail processing system having a mail conveyor and a camera assembly positioned adjacent the mail conveyor. The camera assembly includes a first imaging array and a second imaging array. The mail processing system also has a mailpiece position sensor adapted and arranged to provide an indication of a mailpiece on the mail conveyor at a position relative to the camera assembly. As part of the method, in response to an output of the position sensor, a first image of the mailpiece is acquired with the first image array. In response to the output of the position sensor, a second image of the mailpiece is also acquired with the second image array.

### BRIEF DESCRIPTION OF THE DRAWINGS

FIG. 1 is a diagram of a prior art mail sorting system;

FIG. 2 is a diagram of an illustrative example of a mail sorting system in which embodiments of the invention may be implemented;

FIG. 3 is a diagram of another illustrative example of a mail sorting system in which embodiments of the invention may be implemented;

FIG. 4 shows a partial-cutaway, perspective view of the image lifting stage of the system shown in FIGS. 2 and 3;

FIG. 5 shows a top view of the image lifting stage shown in FIG. 4;

FIG. 6 shows a partial-cutaway, perspective view of one of the camera assemblies shown in FIG. 4;

FIG. 7 shows a top view of the camera assembly shown in FIG. 6;

FIG. 8 shows an exploded view of the camera assembly shown in FIG. 6;

FIG. 9 shows an exploded view of the nose assembly portion of the camera assembly shown in FIG. 6;

FIG. 10 shows a partial-cutaway, perspective view of the base assembly portion of the camera assembly shown in FIG. 6;

FIGS. 11 and 12 show a low-resolution UV image of a mailpiece with a UV-reactive meter mark and a grayscale image of the same mailpiece, respectively, which images were taken by a camera assembly like that shown in FIG. 6;

FIGS. 13 and 14 show a UV image of a mailpiece with a UV-reactive IBI barcode and a grayscale image of the same mailpiece, respectively, which images were taken by a camera assembly like that shown in FIG. 6;

FIGS. 15 and 16 show a UV image of a mailpiece with a UV-reactive ID tag and a grayscale image of the same mailpiece, respectively, which images were taken by a camera assembly like that shown in FIG. 6;

FIG. 17 is a top view of a camera assembly according to an embodiment of the invention; and

FIG. 18 is a flowchart of the operation of a mail processing system according to an embodiment of the invention.

### DETAILED DESCRIPTION

We have appreciated that existing mail processing equipment could be improved with improved and differently organized system components. Improvements in the type and organization of components may, for example, increase the speed or accuracy with which mail is sorted. Additionally, improvements may reduce the overall cost and increase the reliability of mail processing equipment.

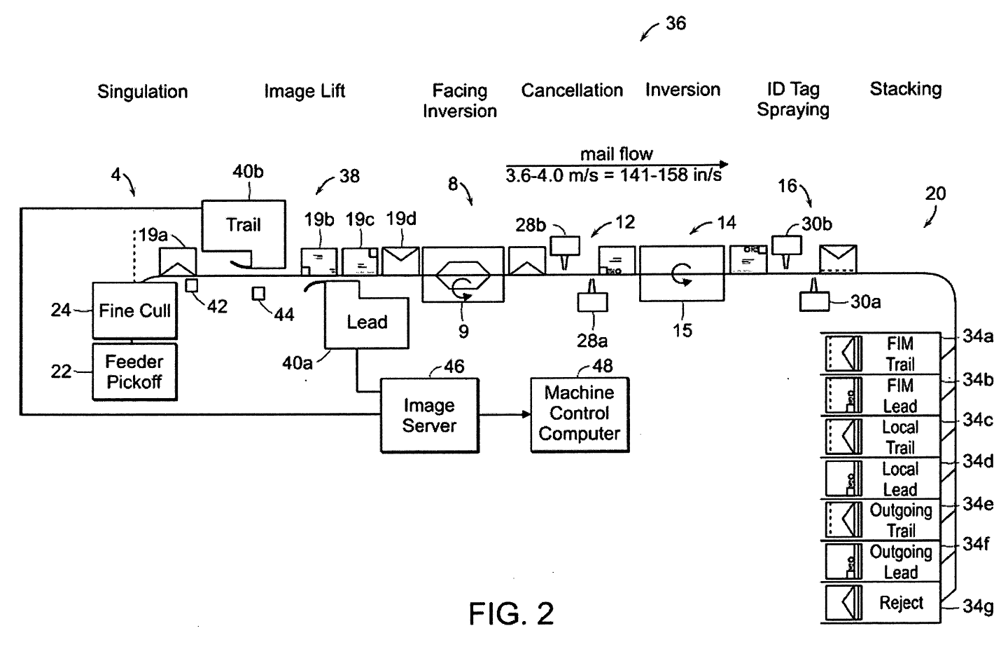

An illustrative example of a mail processing system embodying improved and differently organized components is shown in FIG. 2. In this example, the mail processing system is a mail sorting system in which mailpieces are carried through the system on a mail conveyor, such as a belt or series of belts. As mailpieces pass through the system, they are imaged. The image information may be used for routing the mailpieces to appropriate output locations. In addition, the image information may be used within the mail sorting system for tasks such as determining whether postage is affixed, locating indicia to which a cancellation mark is applied, or positioning a bar code or similar markings on the mailpiece or determining of other markings, features and characteristics of the mailpiece.

Details concerning the structure and operation of mail processing systems according to some embodiments are provided in Application Ser. No. 60/819,136, entitled MULTIPLE ILLUMINATION SOURCES TO LEVEL SPECTRAL RESPONSE FOR MACHINE VISION CAMERA and bearing attorney docket nos. L0562.70061US00 and Application Ser. No. 60/819,084, entitled SYNCHRONIZATION OF STROBED ILLUMINATION WITH LINE SCANNING OF CAMERA and bearing attorney docket nos. L0562.70064US00. Both of which are filed on even date herewith and are incorporated herein by reference in their entireties.

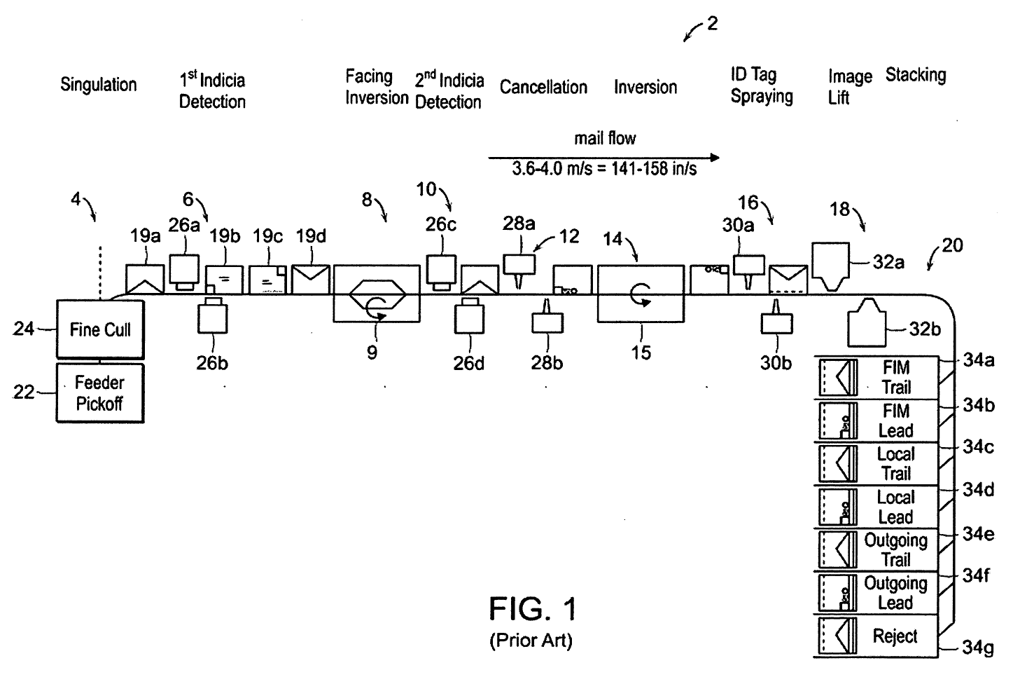

As shown, mail sorting system 36 of FIG. 2 is similar to the mail sorting system 2 of FIG. 1 insofar as it comprises a singulation stage 4, a facing inversion stage 8, a cancellation stage 12, an inversion stage 14, an ID tag spraying stage 16, and a stacking stage 20. In contrast to the system 2, however, in the system 36, all of the functionality of the first indicia detection stage 6, the second indicia detection stage 10, and the image lifting station 18 may be achieved by a single pair of camera assemblies 40a-b (described in more detail below) included in an image lifting stage 38. As shown, the image lifting stage 38 is located between the singulation stage 4 and the facing inversion stage 8 of the system 36, but image lifting stage 38 may be incorporated into system 36 in any suitable location.

In operation, each of the camera assemblies 40a-b acquires both a low-resolution UV image and a high-resolution grayscale image of a respective one of the two faces of each passing mailpiece 19. Because the UV images are of the entire face of the mailpiece, rather than just the lower one inch edge, there is no need to invert the mailpiece when making a facing determination.

Each of the camera assemblies illustrated in FIG. 2 is constructed to acquire both a low-resolution UV image and a high-resolution grayscale image, and such assemblies may be used in embodiments of the invention. It should be appreciated, however, the invention is not limited in this respect. Components to capture a UV image and a grayscale image may be separately housed in alternative embodiments. It should be further appreciated that the invention is not limited to embodiments with two or more camera assemblies as shown. A single assembly could be constructed with an opening through which mailpieces may pass, allowing components in a single housing to form images of one or multiple faces of a mailpiece. Similarly, optical processing, such as through the use of mirrors, could allow a single camera assembly to capture images of one or multiple faces of a mailpiece.

Further, it should be appreciated that UV and grayscale are representative of the types of image information that may be acquired rather than a limitation on the invention. For example, a color image may be acquired. As another example, an acquired image may be binarized for processing in some embodiments. In those embodiments, grayscale information need not be collected or retained and each image pixel may be simply represented by a single digital value. Consequently, any suitable imaging components may be included in system 36.

As shown, the system 36 may further include an item presence detector 42, a belt encoder 44, an image server 46, and a machine control computer 48. The item presence detector 42 (examples of an item presence detector are a “photo eye” or a “light barrier”) may be located, for example, five inches upstream of the trail camera assembly 40b, to indicate when a mailpiece is approaching. The belt encoder 44 may output pulses (or “ticks”) at a rate determined by the travel speed of the belt. For example, the belt encoder 44 may output two hundred and fifty six pulses per inch of belt travel. The combination of the item presence detector 42 and belt encoder 44 thus enables a relatively precise determination of the location of each passing mailpiece at any given time. Such location and timing information may be used, for example, to control the strobing of light sources in the camera assemblies 40a-b to ensure optimal performance independent of variations in belt speed.

Image information acquired with the camera assemblies 40a-b or other imaging components may be processed for control of the mail sorting system or for use in routing mailpieces passing through the system 36. Processing may be performed in any suitable way with one or more processors. In the illustrated embodiment, processing is performed by image server 46.

The image server 46 may receive image data from the camera assemblies 40a-b, and process and analyze such data to extract certain information about the orientation of and various markings on each mailpiece. In some embodiments, for example, images may be analyzed using a neural network, a pattern analysis algorithm, or a combination thereof. Either or both of the grayscale images and the UV images may be so processed and analyzed, and the results of such analysis may be used by other components in the system 36, or perhaps by components outside the system, for sorting or any other purpose.

In the embodiment shown, information obtained from processing images is used for control of components in the system 36 by providing that information to a separate processor that controls the system. The information obtained from the images, however, may additionally or alternatively be used in any other suitable way for any of a number of other purposes. In the pictured embodiment, control for the system 36 is provided by a machine control computer 48. Though not expressly shown, the machine control computer 48 may be connected to any or all of the components in the system 36 that may output status information or receive control inputs. The machine control computer 48 may, for example, access information extracted by the image server 46, as well as information from other components in the system, and use such information to control the various system components based thereupon.

Details concerning particular algorithms executed by the image server 46 and other hardware or firmware in the system are provided in application Ser. Nos. 11/482,386, 11/482,418, 11/482,421, 11/482,423, and 11/482,561, filed on even date herewith, respectively entitled DETECTION AND IDENTIFICATION OF POSTAL INDICIA, SYSTEM AN METHOD FOR REAL-TIME DETERMINATION OF THE ORIENTATION OF AN ENVELOPE, ARBITRATION SYSTEM FOR DETERMINING THE ORIENTATION OF AN ENVELOPE FROM A PLURALITY OF CLASSIFIERS, DETECTION AND IDENTIFICATION OF POSTAL METERMARKS, POSTAL INDICIA CATEGORIZATION SYSTEM, and bearing attorney docket nos., LM(F)8227, LM(F)8228, LM(F)8229, LM(F)8230, LM(F)8231. Each of the foregoing applications is incorporated herein by reference in its entirety.

In the example shown, the camera assembly 40a is called the “lead” assembly because it is positioned so that, for mailpieces in an upright orientation, the indicia (in the upper right hand corner) is on the leading edge of the mailpiece 19 with respect to its direction of travel. Likewise, the camera assembly 40b is called the “trail” assembly because it is positioned so that, for mailpieces in an upright orientation, the indicia is on the trailing edge of the mailpiece with respect to its direction of travel. Upright mailpieces themselves are also conventionally labeled as either “lead” or “trail” depending on whether their indicia is on the leading or trailing edge with respect to the direction of travel.

Following the last scan line of the lead camera assembly 40a, the image server 46 may determine an orientation of “flip” or “no-flip” for the inverter 9. In particular, the inverter 9 is controlled so that that each mailpiece 19 has its top edge down when it reaches the cancellation stage 12, thus enabling one of the cancellers 28a-b to spray a cancellation mark on any indicia properly affixed to a mailpiece by spraying only the bottom edge of the path (top edge of the mailpiece). The image server 46 may also make a facing decision that determines which canceller (lead 28a or trail 28b) should be used to spray the cancellation mark. Other information recognized by the image server 46, such as IBI, may also be used, for example, to disable cancellation of IBI postage since IBI would otherwise be illegible downstream.

After cancellation, all mailpieces may be inverted by the inverter 15, thus placing each mailpiece 19 in its upright orientation. Immediately thereafter, an ID tag may be sprayed using one of the ID tag sprayers 30a-b that is selected based on the facing decision made by the image server 46. In some embodiments, all mailpieces with a known orientation may be sprayed with an ID tag. In other embodiments, ID tag spraying may be limited to only those mailpieces without an existing ID tag (forward, return, foreign).

Following application of ID tags, the mailpieces 19 may ride on extended belts for drying before being placed in output bins or otherwise routed for further processing. In the example shown, there are seven output bins 34a-g. Except for rejects (bin 34g), the output bins 34a-f are in pairs to separate lead mailpieces from trail mailpieces. It is desirable for the mailpieces 19 in each output bin to face identically. The operator may thus rotate trays properly so as to orient lead and trail mailpieces the same way. The mail may be separated into four broad categories: (1) FIM A&C (FIM with POSTNET), (2) outgoing (destination is a different SCF), (3) local (destination is within this SCF), and (4) reject (detected double feeds, not possible to sort into other categories). The decision of outgoing vs. local, for example, may be based on the image analysis performed by the image server 46.

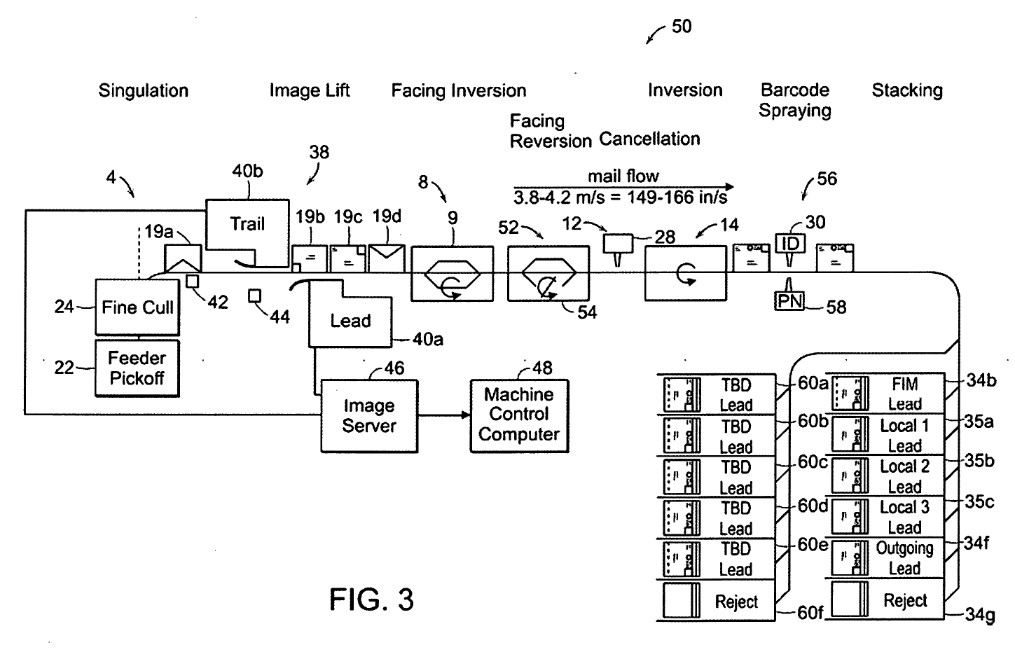

FIG. 3 shows another illustrative example of a mail sorting system embodying various aspects of the invention. The system 50 of FIG. 3 is similar to the system 36 of FIG. 2, but there are a few significant differences. One such difference is that the system 50 includes a facing reversion stage 52 (including a reverser 54) in addition to the facing inversion stage 8. The reverser 54 may be used to ensure that all mailpieces 19 are in the same orientation before they reach the cancellation stage 12 by selectively reversing (flipping horizontally) those mailpieces that are facing opposite the desired direction. Because all mailpieces are known to have the same orientation when they reach the cancellation stage 12, it is possible to employ only a single cancellation sprayer 28 in that stage.

Another difference between the system 50 of FIG. 3 and the system 36 of FIG. 2 is that, in the system 50, a barcode spraying stage 56 includes a single ID tag sprayer 30 as well as a single POSTNET sprayer 58, whereas, in the system 30, the ID tag spraying stage 16 included a pair of ID tag sprayers 30a-b. Again, the provision of the facing reversion stage 52 enables only a single sprayer of each type to be employed, because the precise orientation of all passing mailpieces 19 is known (i.e., they are all in a lead orientation).

Because it is known that all mailpieces are in a lead orientation, there is also no need for separate bins for lead and trail mailpieces, like in the embodiment of FIG. 2. In the example shown, three separate local lead bins 35a-c are employed in lieu of the trail bins 34a, 34c, and 34e of the system 36, thus enabling a finer level of sorting of local mail by the system 50. The system 50 also includes several additional output bins 60a-f into which mail can be sorted depending on the analysis done by the image server 46 on UV and/or grayscale images accumulated by the camera assemblies 40a-b.

As illustrated by the embodiments of a mail processing system shown in FIGS. 2 and 3, it is desirable for decisions to be made as a mailpiece passes through the system. The speed and accuracy with which the information to make such decisions can be acquired and processed can impact the overall speed and accuracy of the entire mail processing system. In the illustrated embodiments, both the speed and accuracy of mail processing is improved with an improved image lifting stage 38.

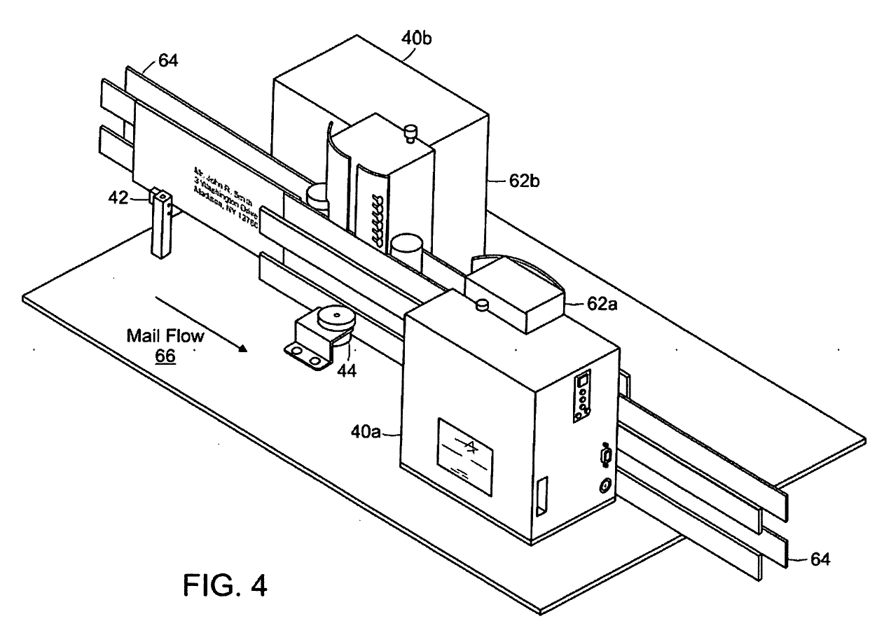

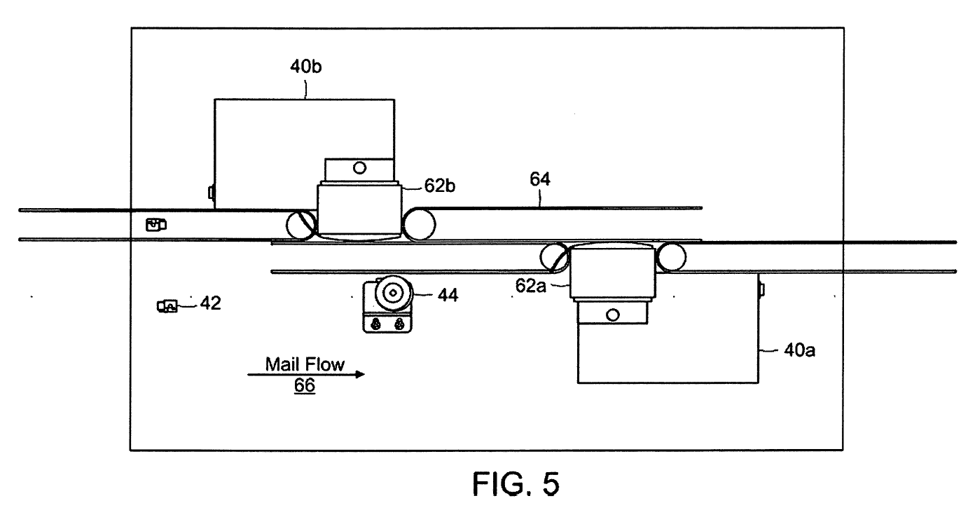

FIGS. 4 and 5 shown perspective and top views of an illustrative example of an improved image lifting stage 38 that may be used in the systems illustrated in each of FIGS. 2 and 3 or in other suitable mail processing applications. In FIG. 4, portions of the housings for the camera assemblies 40a-b have been removed. As shown, several conveyor belts 64 are arranged to move a mailpiece 19 past nose assemblies 62a-b of the camera assemblies 40a-b in the direction of the arrow 66 so that the camera assemblies 40a-b can acquire images thereof. Ideally, the faces of the mailpieces 19 are caused to maintain physical contact with the front portions of the nose assemblies 62a-b during the imaging process so that the distance between the camera and the mailpiece is kept constant.

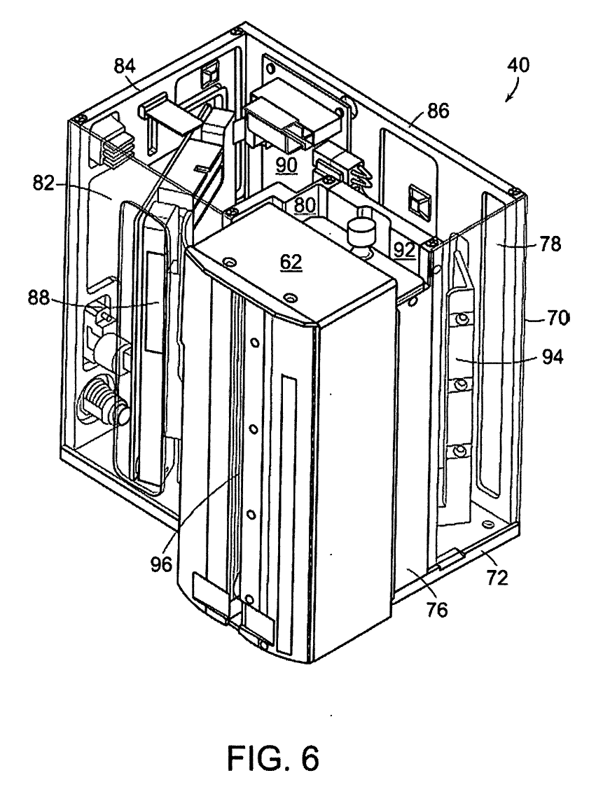

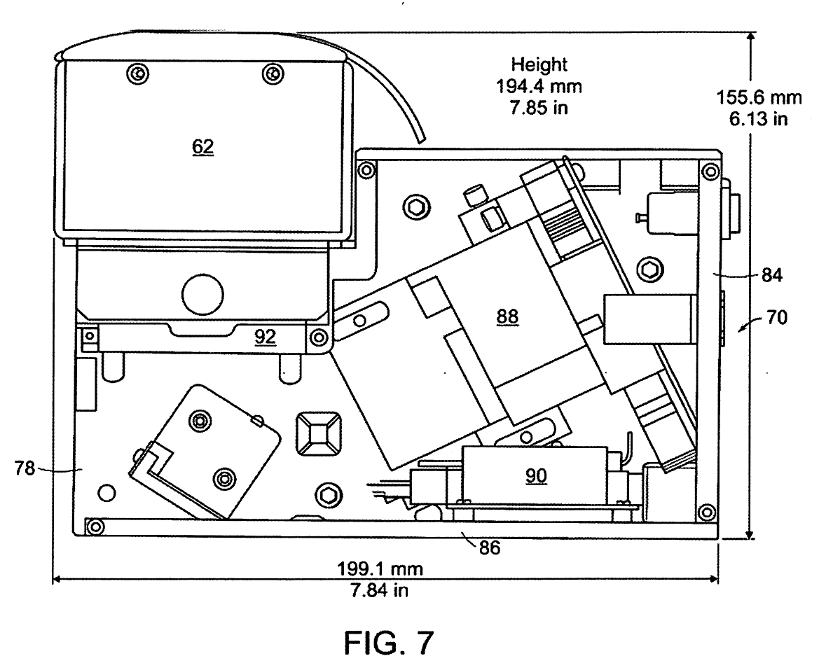

Several views of an illustrative embodiment of a camera assembly 40, and components thereof, are shown in FIGS. 6-10. As shown, each camera assembly 40 may comprise a nose assembly 62 detachably mounted to a base assembly 70. The base assembly 70 may comprise a housing formed of a base plate 72, top cover 74, and panels 76, 78, 80, 82, 84, 86. These panels may act as a housing to enclose the components of the assembly. These panels may additionally or alternatively serve as part of the support structure for components of the assembly.

In the example shown, enclosed within the housing are an optical bench assembly 88, a camera interface board (CIB) 90, a connector 92 for the nose assembly 62, and a mirror assembly 94. The optical bench assembly may, for example, contain an imaging array, such as a charge coupled device (CCD) (not shown), that produces lines of a grayscale image representative of the intensity of light transmitted through a slit 96 in the front of the nose assembly 62 and reflected from the mirror 94 onto the CCD of the optical bench assembly 88. Since the structure and function of the optical bench assembly 88 is essentially the same as that described in United States Application Publication No. 2006/0120563 A1, which is incorporated herein by reference in its entirety, the details of that structure will not be further described. It should be appreciated, however, that any of the other features or functionality of the camera assemblies, components thereof, and systems described in that published application may additionally or alternatively be employed in connection with various embodiments of the camera assemblies and overall system described herein.

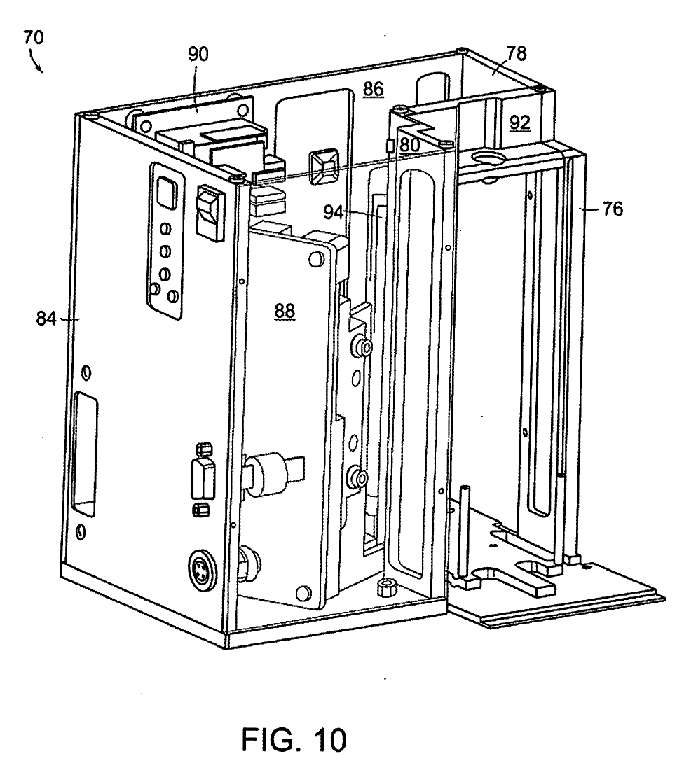

The CIB 90 may provide an electrical and communications link amongst the optical bench assembly 88, the nose assembly 62, and external devices (not shown in FIGS. 6-10). Such external devices may, for example, communicate with the camera assembly components via ports on the back panel 84 (see FIG. 10). The CIB 90 may, for instance, communicate UV and/or grayscale image data to the image server 46 (see FIGS. 2 and 3) via one or more Cameralink connections. In some embodiments, moreover, the CIB 90 may receive inputs from the item presence detector 42 and belt encoder 44 (shown in FIGS. 2 and 3), and selectively control activation of illumination sources and image acquisition components so as to accurately acquire high-quality images of a proper resolution, independent of changes in belt speed.

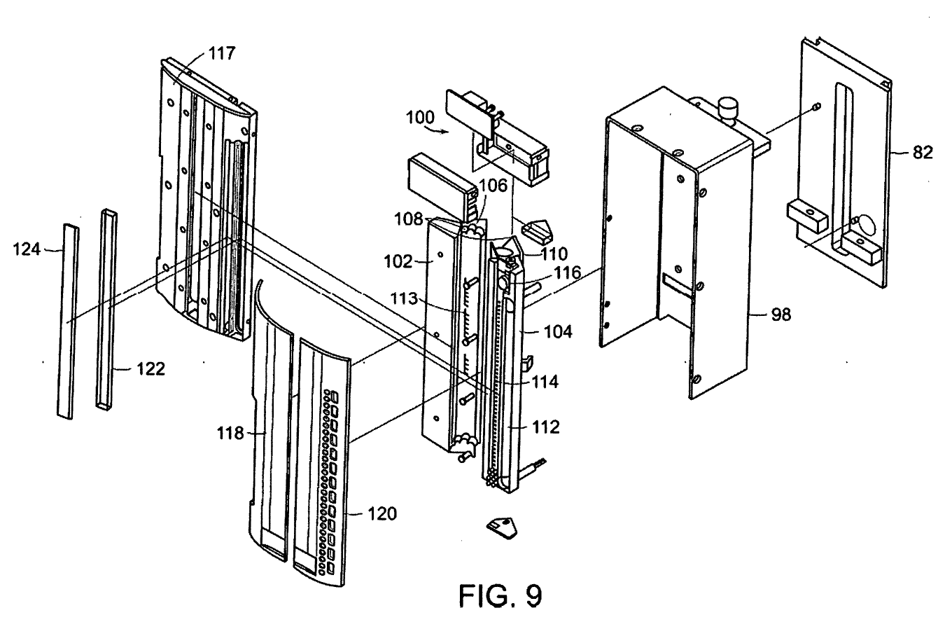

FIG. 9 shows an exploded view of an illustrative embodiment of the nose assembly 62. As shown, the nose assembly 62 may comprise a housing 98 in which are disposed a power supply 100 for a source of UV radiation 112 (discussed below), and a pair of aluminum support members 102, 104 having various components disposed thereon. In the example shown, the support member 102 supports a light source, which is here shown as an LED assembly 106. LED assembly 106 may be constructed from a circuit board or other suitable substrate having disposed thereon a large number of light emitting diodes (LEDs) 108. Likewise the support member 104 may support a similar LED assembly 110, which may also contain a circuit board and may also having a large number of LEDs 108 disposed thereon. The LED assemblies 106, 110 may be identical, but such is not required. In the illustrative embodiment shown, twenty nine rows of three LEDs 108 are disposed on each of the LED assemblies 106, 110, and a diffuser 113 is disposed in front of each group of eighty seven LEDs 108. In some embodiments, LEDs of different colors may be included amongst the white LEDs, and in some embodiments may be selectively controlled, so as to improve the response spectrum of the camera system.

As shown, the aluminum support member 104 may also support a source of UV radiation 112 and an array of phototransistors 114 arranged to receive light reflected from a mailpiece exposed to UV radiation from the source 112. In the example shown, the UV radiation source 112 is a florescent tube, but a set of UV generating diodes, or any other UV generating means, could alternatively be employed as the source of UV radiation 112. In some embodiments, the phototransistors 114 (or some other simple photon receptors) each contain an integrated lens, thus eliminating the need for focusing and calibration. Additional details concerning the structure and operation of the UV radiation source 112 and phototransistors 114 are provided in Application Ser. No. 60/819,188, entitled MAIL PROCESSING SYSTEM WITH LOW RESOLUTION UV IMAGING SUBSYSTEM, bearing attorney docket number L0562.70067US00 and filed on even date herewith, which is incorporated herein by reference in its entirety. Moreover, details concerning the control of the UV radiation source 112 so that it is shut off during periods of non-use of the system or when the housing assembly is opened or has been compromised are provided in Application Ser. No. 60/819,414, entitled MAIL IMAGING SYSTEM WITH UV ILLUMINATION INTERRUPT, bearing attorney docket number L0562.70062US00, and filed on even date herewith, which is incorporated herein by reference in its entirety. In the example shown, analog outputs of the phototransistors 114 are provided to an analog-to-digital converter (ADC) 116 where they are converted to a digital signal prior to being fed to the CIB 90 for further processing.

In the embodiment shown, the aluminum support members 102, 104 and associated components are covered by a platen 117 having a specialized configuration. The platen 117, in turn, is covered by a pair of wear plates 118, 120 also having a specialized design. Details concerning the specialized structure and function of the platen 117 and wear plates 118, 120 are provided in Application Ser. No. 60/819,217, entitled MAIL IMAGING SYSTEM WITH SECONDARY ILLUMINATION/IMAGING WINDOW, bearing attorney docket number L0562.70063US00, and filed on even date herewith, which is incorporated herein by reference in its entirety.

As shown, the UV radiation source 112 and array of phototransistors 114 may each be covered by a respective filter 122, 124 to enhance the accuracy of the UV image acquisition. In the embodiment shown, performance is enhance by placing a short pass filter 122 (allowing UV radiation to pass and blocking visible illumination) in front of the UV radiation source 112, and placing a long pass filter (allowing visible radiation to pass and blocking UV radiation) in front of the array of phototransistors 114. Additional details concerning the mechanisms and techniques used to filter the light generated by the UV radiation source 112 and received at the array of phototransistors 114 are provided in Application Ser. No. 60/819,132, entitled MAIL PROCESSING SYSTEM WITH RADIATION FILTERING, bearing attorney docket number L0562.70065US00 and filed on even date herewith, which is incorporated herein by reference in its entirety.

The radiation source 112 and array of phototransistors 114 may be arranged so that their operation does not interfere with the operation of optical bench assembly 88 in acquiring grayscale images. Advantageously, however, because they are acquired by components within the same camera assembly 40, the UV images and grayscale images acquired by the different components can be correlated with one another to facilitate the identification of the various markings on scanned mailpieces.

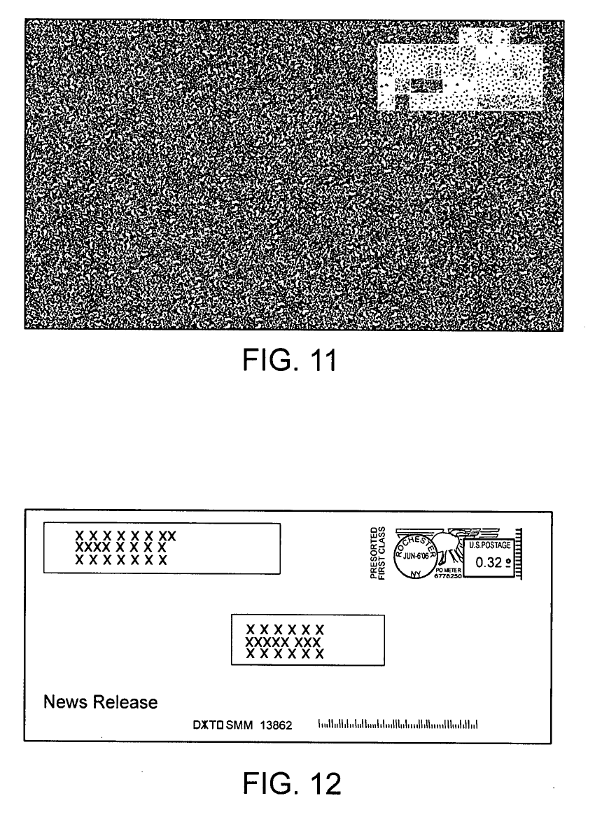

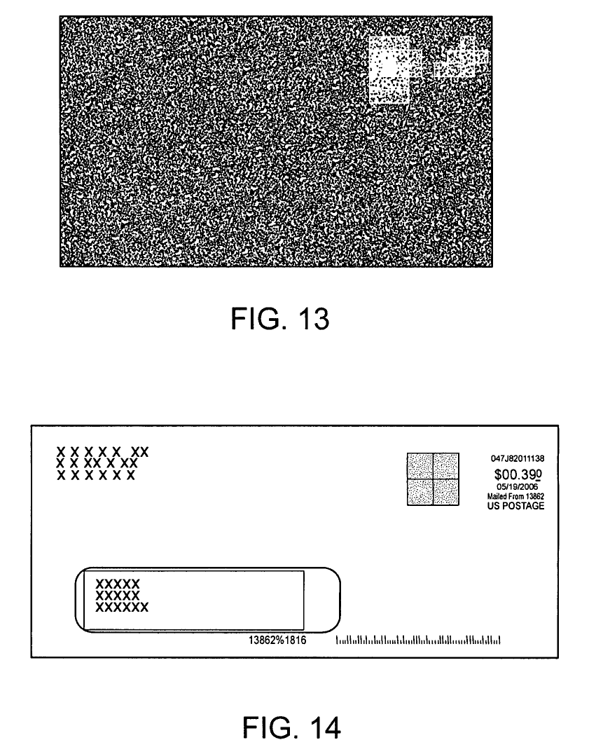

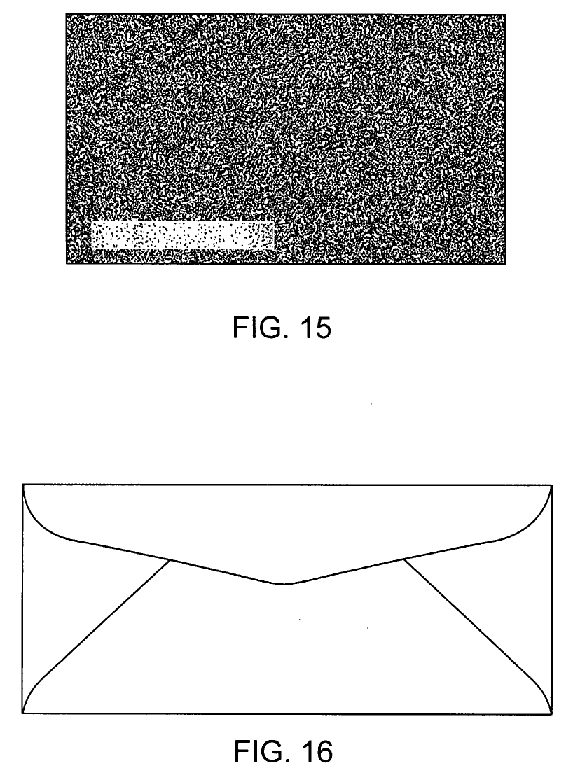

Examples of UV and grayscale images acquired of mailpieces by one of the camera assemblies 40 are shown in FIGS. 11-16, with names and addresses redacted where legible. In particular, FIG. 11 shows a low-resolution UV image of a mailpiece with a UV-reactive meter mark, and FIG. 12 shows a grayscale image of the same mailpiece. Similarly, FIG. 13 shows a UV image of a mailpiece with a UV-reactive IBI barcode, and FIG. 14 shows a grayscale image of the same mailpiece. Finally, FIG. 15 shows a UV image of a mailpiece with a UV-reactive ID tag, and FIG. 16 shows a grayscale image of the same mailpiece.

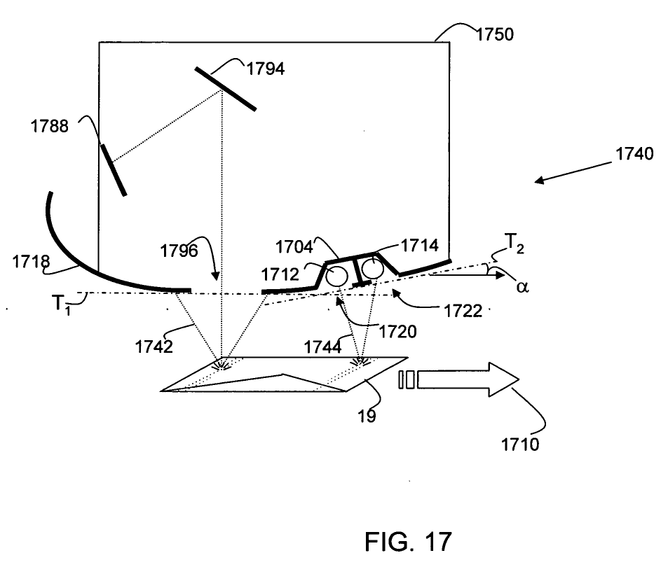

Turning to FIG. 17, additional details of a camera assembly 1740 according to an embodiment of the invention are illustrated. Camera assembly 1740 may be generally in the form of camera assembly 40 (FIG. 6) and may incorporate components as described above, though the structural details of camera assembly 40 serve only as an example embodiment and are not critical to the invention.

Camera assembly 1740 contains two cameras within housing 1750. Both camera assemblies may image mailpiece 19 as it passes face 1718 of camera assembly 1740.

As shown in FIG. 17, mailpiece 19 may move on a mail conveyor of any suitable design. In the embodiment illustrated, a mail conveyor (not shown) moves mailpiece 19 in direction 1710 past the face 1718 of camera assembly 1740. Face 1718 may be formed of any suitable components, such as a wear plate 118 (FIG. 9) and/or a platen 117 (FIG. 9).

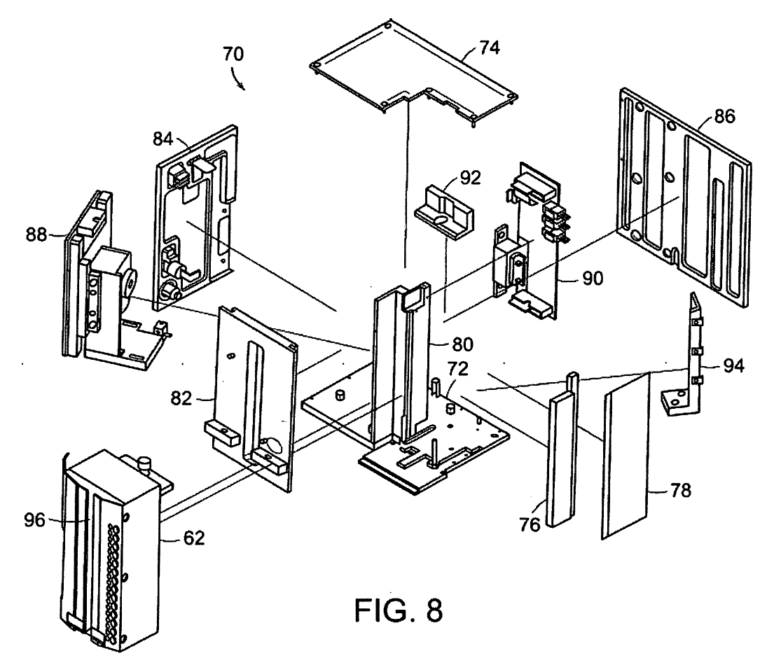

Face 1718 includes one or more apertures through which the individual cameras of the camera assembly 1740 may receive radiation to form images of mailpiece 19. As illustrated, detector array 1788 is a component of a camera that forms a grayscale image. For simplicity, a lens and other components of such a camera as described above are not expressly shown. Detector array 1788 may be a CCD array that forms a portion of an optical bench assembly 88 (FIG. 8), though any suitable detector array may be used. Detector array 1788 receives radiation through aperture 1796.

Aperture 1796 may be elongated, and may be a slit in the form of slit 96 (FIG. 8). However, other aperture shapes may be used, including a plurality of discrete apertures positioned to allow radiation to reach detector array 1788.

Camera assembly 1740 also includes a camera for forming UV images. In the pictured embodiment, the UV camera includes a detector array 1714, which may be a linear array of phototransistors 114 (FIG. 9), though any suitable detector array may be used. Detector array 1714 receives radiation through aperture 1722.

Aperture 1722 may be elongated, and may be a slit in the form of slit 96 (FIG. 8). However, other aperture shapes may be used, including a plurality of discrete apertures positioned to allow radiation to reach detector array 1714.

Radiation to illuminate mailpiece 19 when forming images with a grayscale camera and a UV camera may be provided through apertures in face 1718 or may be provided from radiation sources mounted in face 1718. In the illustrated embodiment, visible light is used to illuminate mailpiece 19 for forming a grayscale image. Such light may be provided by one or more LED arrays in face 1718 as described in United States Application Publication No. 2006/0120563 A1, referenced above.

Accordingly, a grayscale camera may have an optical path 1742. Optical path 1742 initiates at an illumination source, here shown to be within a portion of face 1718. Optical path 1742 extends to a portion of the surface of mailpiece 19. Reflections from mailpiece 19 provide energy for a grayscale image of mailpiece 19. Those reflections are directed by mirror 1794 to detector array 1718.

The UV camera in camera assembly 1740 includes a separate optical path 1744. In the embodiment illustrated, optical path 1744 begins at UV radiation source 1712. UV radiation passes through aperture 1720 and illuminates a portion of mailpiece 19. Interactions between the UV radiation and features on the surface of mailpiece 19 cause those features to emit radiation. As described above, mailpiece 19 may contain features that fluoresce, phosphoresce or scintillate in response to UV radiation. Radiation generated by fluorescence, phosphoresce or scintillation of features on the surface of mailpiece 19 provides energy for a UV image of mailpiece 19. That radiation passes through aperture 1722 to detector array 1714.

Though mailpiece 19 is illuminated with UV radiation, the radiation produced by fluorescence, phosphorescence or scintillation falls in the visible light spectrum. Accordingly, both detector arrays 1788 and 1714 are sensitive to radiation in the visible light spectrum. To avoid interference between the cameras of camera assembly 1740, it may be desirable for optical paths 1742 and 1744 to be separate. As shown, camera assembly 1740 includes one or more mechanisms to keep optical paths 1742 and 1744 separate.

One mechanism that separates optical paths 1742 and 1744 is the shape of face 1718 and the relative position in face 1718 of the apertures through which optical paths 1742 and 1744 pass. As illustrated, face 1718 has a generally convex shape. Tangents to face 1718 are shown in the vicinity of apertures 1796 and 1722. Tangent T₁ is the tangent in the vicinity of aperture 1796. Tangent T₂ is the tangent in the vicinity of aperture 1722.

In the embodiment illustrated, tangent T₁ is generally parallel to a mail conveyor moving mailpiece 19. In contrast, tangent T₂ is offset from the direction 1710 of motion of the mail conveyor by an angle α. In the illustrated embodiment, the angle α is between about 2 and 10 degrees, with the angle being between 5 and 10 degrees in some embodiments.

By positioning the apertures in the different optical paths at locations in the face having different tangents, portions of face 1718 between apertures 1796 and 1722 block radiation from one optical path from reaching the detector array in the other optical path.

Also, to keep the optical paths separate, one or more baffles may be included in camera assembly 1740. Support 1704, which may be generally in the form of support 104 (FIG. 9), may act as a baffle. As shown, support 1704 holds UV radiation source 1712 and detector array 1714 against face 1718 while blocking any radiation used for illuminating an image formed by detector array 1788 from reaching detector array 1714. Support 1704 also blocks radiation from UV radiation source 1712 from reaching detector array 1788.

The separation in the optical paths restricts the cameras so that they only include a portion of mailpiece 19 in their optical paths at one time. Despite this restriction, an image of the entire mailpiece may be formed. FIG. 17 shows image information acquired at one instant in time. At that time, one portion of mailpiece 19 falls within optical path 1742. A separate portion of mailpiece 19 falls within optical path 1744. Nonetheless, the entire surface of mailpiece 19 may be imaged because mailpiece 19 may be scanned as it moves past camera assembly 1740. Motion of mailpiece 19 places different portions of the mailpiece within optical paths 1742 and 1744 at different times. An image of one “scan strip” may be collected at each position and all of the scan strips may be assembled electronically into an image. In this way, multi-dimensional images of mailpiece 19 may be acquired.

In the pictured embodiment, each detector array is sufficiently long to provide a wide field of view. In this context, the field of view is sufficient to image the entirety of most mailpieces or at least a substantial percentage of a surface of a mail piece of the maximum size the mail processing system can physically process. In some embodiments, the field of view will be in excess of 12 cm. In other embodiments, the field of view may be about 15 cm or more.

For simplicity and low cost, detector array 1714 has a low resolution and may be a linear array. For example detector array 1714 may have 1 to 3.5 detectors/cm. Detector array 1788 may have higher resolution, but any suitable detector arrays may be used.

To acquire an image by scanning, the position of mailpiece 19 may be detected and then motion of the mailpiece may be tracked so that scan strips may be collected at the desired locations across mailpiece 19. As described above, a mail processing system may include an item presence detector 42 (FIG. 2) and a belt encoder 44 (FIG. 2). These units may provide information on the presence and location of a mailpiece 19 entering camera assembly 1740. By having multiple cameras within housing 1750, both cameras will have a fixed position relative to item presence detector 42, allowing one item presence detector and one belt encoder to be used for control of all cameras within camera assembly 1740. As a result, construction and maintenance of a mail processing system using a camera assembly such as 1740 may be simplified.

In addition, the images acquired by all cameras within camera assembly 1740 may be easily processed. The images may be passed through an interface, such as CIB 90 (FIG. 8), to the same data processing system. The information relating to both images may be provided in such a way that the image information is spatially correlated. In this way, locations within one image may be readily identified in another image.

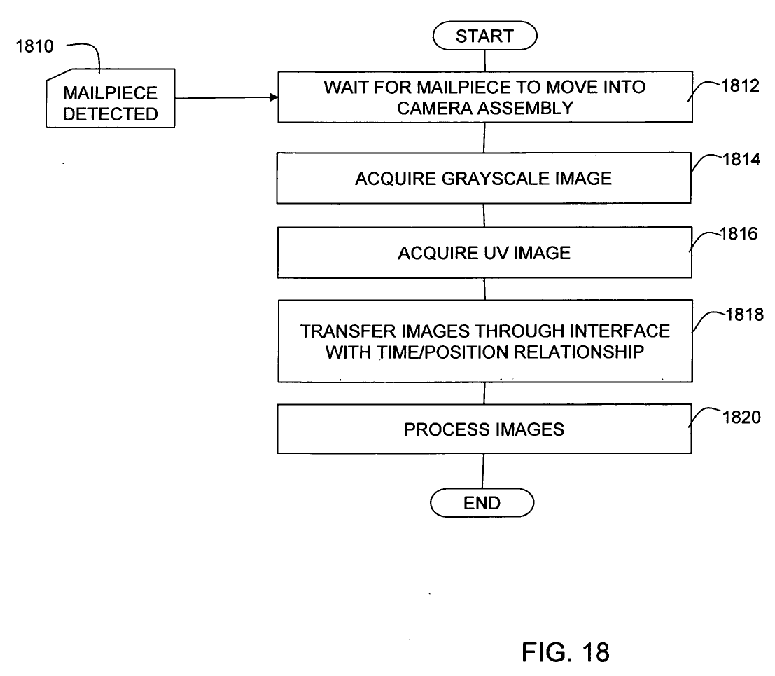

FIG. 18 illustrates a process by which a mail processing system incorporating a camera assembly such as camera assembly 1740 may process a mailpiece. The process begins at block 1810 when a mailpiece is detected on a mail conveyor moving mail toward the camera assembly.

When a mailpiece is detected, the process proceeds to block 1812. At block 1812, the process waits until the mailpiece moves into the camera assembly and is in position for scanning. In this example, the process waits until the forward edge of the mailpiece is in position for a first scan line to be acquired. In an embodiment using a belt encoder, the length of the wait may be determined by using the belt encoder to detect motion of the mail conveyor by an amount equal to the distance between the presence detector and the location at which the mailpiece intersects optical path 1742.

Thereafter, the process proceeds to block 1814 where subsequent scan lines of a grayscale image are acquired as the mailpiece moves past camera assembly 1740. The belt encoder may likewise be used to determine when the mailpiece is positioned for the next scan line.

In block 1816, a UV image is acquired. The UV image may also be acquired by scanning. Accordingly,.the process of acquiring a UV image may begin when the mail conveyor has moved the mailpiece past the presence detector by an amount equal to the distance between the presence detector and the location at which the mailpiece intersects optical path 1744. Subsequent scan lines of the UV image may be acquired as the mailpiece moves past camera assembly 1740.

Though FIG. 18 shows blocks 1814 and 1816 to be sequential, this arrangement is shown for simplicity. As pictured in FIG. 17, at least some scan lines of the grayscale image and the UV image are acquired simultaneously. Accordingly, all or a portion of the processing at blocks 1814 and 1816 may occur simultaneously.

At block 1818, the acquired images are transferred through an interface to a data processing system. In the described embodiment, both images are passed through the same interface. The images may be passed to image server 46 (FIG. 2) or any other suitable processing device.

In an embodiment, the images are passed in digital form through a port, such as port 1010 (FIG. 10), to which a physical connection may be made to a data processing system. Port 1010 may be coupled inside the camera assembly to a camera interface board, such as CIB 90 (FIG. 10). However, the images may be passed in any suitable way.

In some embodiments, the positional relationship between the images is retained as the images are passed through the interface. Specifically, each scan line of the images depicts a portion of the mailpiece under inspection. As part of acquiring each image, the position of the mailpiece is determined. As a result, the position on the mailpiece corresponding to each scan line can be determined. Information on each image passed through the interface may identify either the position on the mailpiece of each scan line or may allow the scan lines in the images to be correlated so that any location in one image can be correlated to a location in the other image.

At block 1820, the images are analyzed to identify features on the mailpiece under inspection. The specific processing performed at block 1820 may depend on the specific functions of the mail processing system in which the process is performed. For example, processing may involve detecting the orientation of the mailpiece based on the location of a scintillating or fluorescent feature on the mailpiece. Once the orientation of the mailpiece is detected, that information may be used to change the orientation of the mailpiece. For example, the processing may be based on identifying an image of one or more of a stamp, a meter mark, an information-based indicia and an identification tag and, following detection of a feature, the mailpiece may be reoriented to position the feature in the top forward corner of the mailpiece as the mailpiece moves along the mail conveyor.

In some embodiments, processing at block 1820 will be based on a low resolution UV image of the mailpiece. For example, the image may be formed from a detector array having individual detectors spaced on a pitch between about 8.2 mm and 3 mm, with a resulting image resolution between about 1 and 3.5 pixels/cm. Such a low resolution allows rapid and accurate feature detection with low cost components. In other embodiments, the processing may be based on a gray scale image of the mailpiece having higher resolution, such as between about 50 and 150 pixels/cm. Such processing may result in the identification of the zip code or other portions of an address on a mailpiece, the amount of postage affixed to the mailpiece or any other information on the mailpiece.

In yet further embodiments, processing may be based on both a UV image and a grayscale image. Such processing, for example, may include use of the UV image to guide analysis of the grayscale image. For example, the UV image may be used to identify a stamp or other feature on the mailpiece. Because the location of a feature in the UV image can be readily correlated to a location in the grayscale image, image processing operations intended to extract information from a feature can be performed only on portions of the image actually containing the features. In this way, processing requirements for analysis of the grayscale image may be reduced by using a correlated UV image and grayscale image formed by two imaging arrays in a single camera assembly.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A mail processing system having a camera assembly, the camera assembly comprising:
a) a housing, the housing comprising a face having at least a first aperture and a second aperture;
b) a first imaging array mounted within the housing, the first imaging array positioned to receive radiation passing through the first aperture; and
c) a second imaging array mounted within the housing, the second imaging array positioned to receive radiation passing the second aperture.

2. The mail processing system of claim 1, further comprising a mail conveyor adapted and arranged to convey mailpieces past the face of the housing.

3. The mail processing system of claim 2, further comprising a source of UV radiation adapted and arranged to illuminate a mailpiece passing the face of the housing, whereby radiation emanating from the mailpiece in response to UV radiation passes through the second aperture.

4. The mail processing system of claim 3, wherein the face is positioned relative to the UV radiation source to block the radiation emanating from the mailpiece in response to UV radiation from passing through the first aperture.

5. The mail processing system of claim 2, wherein the camera assembly comprises a first camera assembly and the mail processing system additionally comprises a second camera assembly having a second face, the second face positioned on an opposite side of the mail conveyor from the first camera assembly.

6. The mail processing system of claim 1, wherein the second imaging array is a linear array.

7. The mail processing system of claim 6, wherein the first imaging array is a two-dimensional array.

8. The mail processing system of claim 6, wherein the second aperture comprises a continuous aperture along the linear array.

9. The mail processing system of claim 6, wherein the second aperture is a discontinuous aperture comprising a plurality of openings along the linear array.

10. The mail processing system of claim 1, wherein the mail processing system is a mail sorting system.

11. A mail processing system, comprising:
a) a mail conveyor;
b) a camera assembly, the camera assembly comprising:
i) a housing, the housing comprising a face having at least a first aperture and a second aperture, the housing being positioned with the face adjacent the mail conveyor;
ii) a first imaging array mounted within the housing, the first imaging array positioned to receive radiation passing through the first aperture;
iii) a second imaging array mounted within the housing, the second imaging array positioned to receive radiation passing through the second aperture; p2 iv) a first radiation source mounted to the housing and positioned to illuminate a first region of a mailpiece on the mail conveyor, the first region being adjacent the first aperture; and
v) a second radiation source mounted to the housing and positioned to illuminate a second region of the mailpiece on the mail conveyor, the second region being adjacent the second aperture.

12. The mail processing system of claim 11, wherein the first radiation source is a source of visible light.

13. The mail processing system of claim 12, wherein the second radiation source is a source of UV light.

14. The mail processing system of claim 13, wherein the first and second imaging arrays detect visible light.

15. The mail processing system of claim 14, wherein the first imaging array has a resolution smaller than the resolution of the second imaging array.

16. The mail processing system of claim 11, further comprising a camera interface mounted to the housing and adapted to be connected to a data processing system external to the housing, the camera interface providing data representing images acquired with the first imaging array and the second imaging array.

17. The mail processing system of claim 11, wherein the face of the housing is convex and the first aperture is positioned at a first location in the convex face having a first tangent and the second aperture is positioned at a second location in the convex face having a second tangent, different than the first tangent.

18. A method of operating a mail processing system having a mail conveyor and a camera assembly positioned adjacent the mail conveyor, the camera assembly comprising a first imaging array and a second imaging array and the mail processing system having a mailpiece position sensor adapted and arranged to provide an indication of a mailpiece on the mail conveyor at a position relative to the camera assembly, the method comprising:
a) in response to an output of the position sensor, acquiring a first image of the mailpiece with the first image array; and
b) in response to the output of the position sensor, acquiring a second image of the mailpiece with the second image array.

19. The method of claim 18, further comprising passing the first image and the second image through a single interface to a data processing system.

20. The method of claim 18, further comprising processing the first image and the second image, the processing comprising correlating locations in the first image to locations in the second image.
